(19) United States
(12) Patent Application Publication
(10) Pub. No.: US 2007/0201779 A1
(43) Pub. Date: Aug. 30, 2007

(54) Hydrodynamic bearing motor

(75) Inventor: Sang Uk Kim, Seoul (KR)

Correspondence Address: THELEN REID BROWN RAYSMAN & STEINER LLP, P. O. BOX 640640, SAN JOSE, CA, 95164-0640, US

(73) Assignee: G&W TECHNOLOGIES, INC., Incheon-city (KR)

(21) Appl. No.: 11/710,350

(22) Filed: Feb. 22, 2007

(30) Foreign Application Priority Data
Feb. 24, 2006 (KR) 10-2006-0018433

(51) Int. Cl. F16C 32/06

(52) U.S. Cl. 384/107

(57) ABSTRACT

In a hydrodynamic bearing motor which rotatably supports a rotor by forming a hydrodynamic bearing by forming an oil gap between the rotor and a stator, the stator includes a base and a hollow sleeve fixedly coupled to the central portion of the base and having a flange formed at an upper end portion of the sleeve. The rotor includes a shaft forming journal bearings by forming an oil gap in the hollow of the sleeve and rotatably coupled to the hollow of the sleeve 120, a hub having the central portion to which an upper end portion of the shaft is fixedly coupled, having a cylindrical wall extending downward toward the outside of the flange from a lower surface of the hub, and forming an oil gap with an upper surface of the flange, thus forming an upper thrust bearing, and a thrust plate fixedly coupled to an inner circumferential surface of the cylindrical wall and forming a lower thrust bearing with a lower surface of the flange.

### CROSS-REFERENCE TO RELATED PATENT APPLICATION or PRIORITY CLAIM

This application claims the benefit of Korean Patent Application No. 10-2006-0018433, filed on Feb. 24, 2006, in the Korean Intellectual Property Office, the disclosure of which is incorporated herein in its entirety by reference.

### FIELD OF THE INVENTION

The present invention relates to a hydrodynamic bearing motor, and more particularly, to a hydrodynamic bearing motor having an improved structure which can enable the stable operation of a motor and stably prevent the leakage of oil from a bearing portion by including at least one pair of thrust bearings without reducing the length of a journal bearing.

### BACKGROUND OF THE INVENTION

A spindle motor used for a disk driving apparatus that drives a recording disk such as a hard disk employs a hydrodynamic bearing for rotatably supporting a shaft and a sleeve using a hydrodynamic pressure of lubricant such as oil interposed between the shaft and sleeve. U.S. Pat. No. 6,781,268 discloses an example of a hydrodynamic bearing motor employing a hydrodynamic bearing. FIGS. 1 and 2 illustrate a spindle motor of the example of U.S. Pat. No. 6,781,268.

The spindle motor includes a hub 2 consisting of an upper plate portion 2a having a disc shape and a main wall portion 2b having a cylindrical shape and extending downwardly from an outer circumference of the upper plate portion 2a, a shaft 4 having an upper portion that is fixedly coupled at the center of the upper plate portion 2a, a hollow sleeve 8 rotatably supporting the shaft 4, a cover block 10 closing a lower end portion of the sleeve 8, and a housing 14 on which a cylindrical portion 12 coupling and supporting the sleeve 8 is integrally formed.

Lubricant is provided between the upper end surface of the sleeve 8 and the lower surface of the upper plate portion 2a of the hub 2 to form a thrust bearing 20. Also, lubricant is provided between the shaft 4 and the sleeve 8 to form journal bearings 24 and 28.

An oil leakage prevention structure is employed to prevent leakage of lubricant from the thrust bearing 20. The oil leakage prevention structure has a cylindrical wall 2d extending downwardly from the lower surface of the upper plate portion 2a of the hub 2 with a diameter greater than the outer diameter of the sleeve 8 and an inclined surface 8a formed on the outer circumferential surface of the upper end portion of the sleeve 8. A ring member 32 having an inclined surface 32a facing the inclined surface 8a of the sleeve 8 is formed on the inner circumferential surface of the cylindrical wall 2d.

According to the oil leakage prevention structure, the lubricant forms a boundary surface with air between the sleeve and the ring member 32. Thus, the lubricant moves toward the thrust bearing 20 due to a centrifugal force during the rotation of the hub 2 so that the leakage of oil is prevented.

However, the above hydrodynamic bearing motor structure is weak to vibrations in the axial direction because the thrust bearing 20 is installed at only one position in the upper portion thereof. In this regard, an additional magnetic body 26 is provided at a position facing a magnet 25 to add an axial support force by a magnetic force of the magnetic body 26. Thus, it is a problem that an additional element is needed so that the structure is complicated and assembly thereof becomes inconvenient.

Also, since the ring member 32 has the inclined surface 32a, the prevention of escape of the hub 2 from the sleeve 8 is insufficiently considered. Accordingly, when the hub 2 receives an impact during rotation, a tip end portion of the ring member 32 is easily breakable.

FIG. 3 illustrates another conventional hydrodynamic bearing motor which is disclosed in U.S. Pat. No. 6,456,458. Referring to FIG. 3, the conventional hydrodynamic bearing motor includes an inner sleeve 1 having a center hole, a shaft 4 coaxially inserted in the center hole to form a fine gap between the outer circumferential surface thereof and the center hole, an outer sleeve 2 fixing the inner sleeve 1 and fixedly coupled to a base 3, a stator 7 fixed to the outer sleeve 2, a rotor hub 5, to which the shaft 4 is coupled, thus rotating together and extending radially and downwardly, in which a magnet 8 is fixed on an extended inner surface thereof, to face the stator 7, and forming a thrust bearing 9 as a fine gap is formed to radially extend in the axial direction with the end portion of the sleeve 1, a radial hydrodynamic bearing 10 formed on the center hole and the outer circumferential surface of the shaft 4, a taper seal 11 located adjacent to the fine gap of the thrust hydrodynamic bearing 9 and preventing leakage of lubricant, and a ring member 6 coupled to the lower end portion of the shaft 4 and preventing the escape of the hub 5.

However, the above-described spindle motor has a structure in which the taper seal 11 is formed between a cylindrical wall 5a downwardly extending from the hub 5 and the outer circumferential surface of the inner sleeve 1. Thus, when the hub 5 is rotated, the lubricant in the taper seal 11 rotates at high speed along the cylindrical wall 5a so that the lubricant may leak due to the centrifugal force.

That is, in the structure of the taper seal 11, a rotating portion (the cylindrical wall 5a) is provided at the outer side and a fixed portion (the sleeve 1) is provided at the inner side so that a great amount of a centrifugal force is applied to the lubricant and accordingly the lubricant may escape from the taper seal 11 during the driving of the motor. Also, the lubricant may escape from the shaft 4 due to the rotation of the hub 5 or an external impact.

### SUMMARY OF THE INVENTION

To solve the above and/or other problems, the present invention provides a hydrodynamic bearing motor which can secure the operational stability of a motor and is strong to an external impact by including at least one pair of thrust bearings without reducing the length of a journal bearing of the motor.

The present invention provides a hydrodynamic bearing motor which can prevent the leakage of oil during the operation of a motor.

The present invention provides a hydrodynamic bearing motor which can prevent the escape of a rotor.

According to an aspect of the present invention, a hydrodynamic bearing motor which rotatably supports a rotor by forming a hydrodynamic bearing by forming an oil gap between the rotor and a stator, wherein the stator comprises a base; and a hollow sleeve fixedly coupled to the central portion of the base and having a flange formed at an upper end portion of the sleeve, and the rotor comprises: a shaft forming journal bearings by forming an oil gap in the hollow of the sleeve and rotatably coupled to the hollow of the sleeve 120; a hub having the central portion to which an upper end portion of the shaft is fixedly coupled, having a cylindrical wall extending downward toward the outside of the flange from a lower surface of the hub, and forming an oil gap with an upper surface of the flange, thus forming an upper thrust bearing; and a thrust plate fixedly coupled to an inner circumferential surface of the cylindrical wall and forming a lower thrust bearing with a lower surface of the flange.

A first taper seal connected to the lower thrust bearing and extending downward may be formed between an inner circumferential surface of the thrust plate and an outer circumferential surface of the sleeve.

A circular wall extending upward may be formed at the central portion of the base and a second taper seal extending upward may be formed between an inner circumferential surface of the circular wall and an outer circumferential surface of a cylindrical wall.

A first pressure connection hole connecting the journal bearings and the second taper seal may be formed in the sleeve.

A second pressure connection hole connecting the upper/lower thrust bearings and the second taper may be formed in a boundary portion between the cylindrical wall and the thrust plate.

An auxiliary journal bearing preventing the leakage of oil may be formed between an inner circumferential surface of the thrust plate and an outer circumferential surface of the sleeve.

A groove having a herring bone shape may be formed in any one of a lower surface of the flange and an upper surface of the thrust plate which form the lower thrust bearing.

A groove having an inward spiral shape may be formed in any one of an upper surface of the flange and the hub which form the upper thrust bearing.

A coupling groove where the flange is accommodated may be formed in an upper surface of the thrust plate and the upper surface of the thrust plate may be located on the substantially same plane as a surface of the upper thrust bearing.

### BRIEF DESCRIPTION OF THE DRAWINGS

The above and other features and advantages of the present invention will become more apparent by describing in detail preferred embodiments thereof with reference to the attached drawings in which:

FIG. 1 is a sectional view of a conventional hydrodynamic bearing motor;

FIG. 2 is a sectional view showing a major portion of the hydrodynamic bearing motor of FIG. 1;

FIG. 3 is a sectional view of another conventional hydrodynamic bearing motor;

FIG. 4 is a sectional view of a hydrodynamic bearing motor according to an embodiment of the present invention;

FIG. 5 is an exploded sectional view of the hydrodynamic bearing motor of FIG. 4;

FIGS. 6 and 7 are sectional views showing a major portion of the hydrodynamic bearing motor of FIG. 4;

FIGS. 8 through 11 are sectional views showing hydrodynamic bearing motors according to other embodiments of the present invention;

FIG. 12 is a top view of a flange; and

FIG. 13 is a low view of the flange.

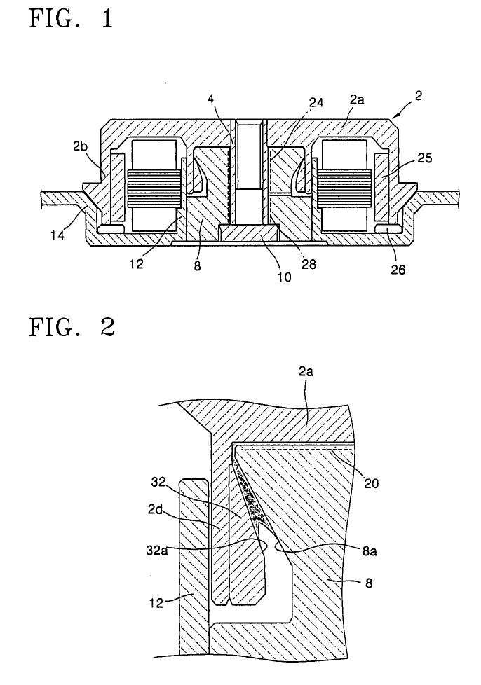

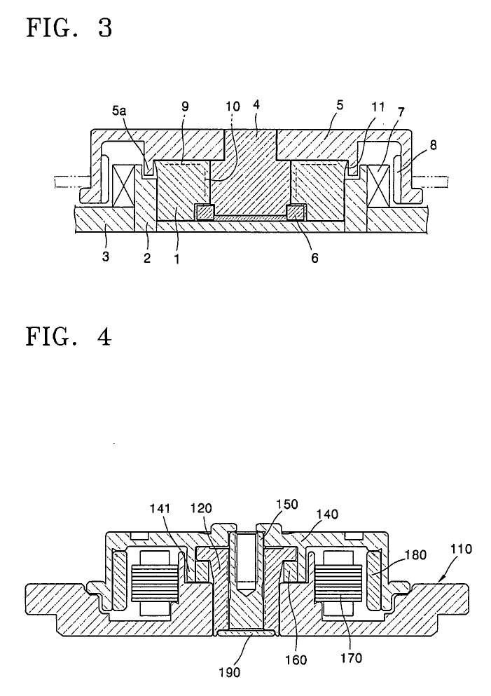

### DETAILED DESCRIPTION OF THE INVENTION

In a hydrodynamic bearing motor according to an embodiment of the present invention, an oil gap is formed between a rotor and a stator, thus forming a hydrodynamic bearing rotatably supporting the rotor, and a recording medium such as a platter is mounted on the rotor.

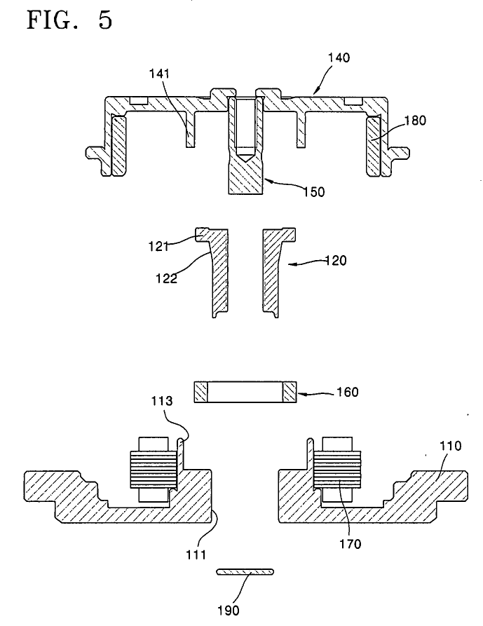

Referring to FIGS. 4 through 7 which show a hydrodynamic bearing motor according to an embodiment of the present invention, the stator includes a base 110 to which a stator core 170 is fixed and a hollow sleeve 120 fixedly coupled to the central portion of the base 110 and having a flange 121 formed at the upper end portion thereof. A coupling hole 111 in which the sleeve 120 is inserted is formed at the central portion of the base 110. A circular wall 113 to which the stator core 170 is fixedly coupled is formed at the central portion of the base 110.

The rotor includes a shaft 150, a hub 140, and a thrust plate 160. The shaft 150 forms journal bearings 51 and 52.by forming an oil gap in the hollow of the sleeve 120 and is rotatably coupled to the hollow of the sleeve 120. The upper end portion of the shaft 150 is fixedly coupled at the central portion of the hub 140. A cylindrical wall 141 extends downward toward the outside of the flange 121 from the lower surface of the hub 140. The cylindrical wall 141 forms an oil gap with the upper surface of the flange 121, thus forming an upper thrust bearing 41. A rotor 180 is fixed at the hub 140 to face the stator core 170. The thrust plate 160 is fixedly coupled to the inner circumferential surface of the cylindrical wall 141 and forms a lower thrust bearing 42 with the lower surface of the flange 121.

The hydrodynamic bearing motor read information contained in a platter (not shown) or records information thereon using a recording and/or reproducing head (not shown) as the hub 140 having the platter and the shaft 150 is rotated at high speed by the electromagnetic interaction between the rotor 180 and the stator core 170.

In the hydrodynamic bearing motor, the flange 121 of the sleeve 120 has a surface contact with the thrust plate 160 that is forcibly inserted in the cylindrical wall 141 so that the sleeve 120 does not escape due to an external impact during the operation of the motor and a stable operation is available.

Also, in the hydrodynamic bearing motor, since the thrust bearings 41 and 42 formed at the flange 121 of the sleeve 120 do not decease the length of the journal bearings 51 and 52, the strength of the bearing can be improved in a low profile hydrodynamic bearing motor. Furthermore, since a pair of the thrust bearings 41 and 42 are used, a stable dynamic characteristic can be obtained with respect to an axial motion.

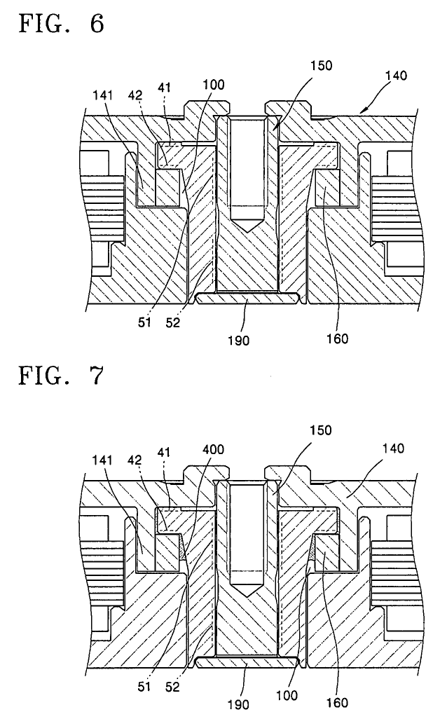

Referring to FIG. 6, in the hydrodynamic bearing motor according to an embodiment of the present invention, a first taper seal 100 connected to the lower thrust bearing 42 and extending downward is formed between the inner circumferential surface of the flange 121 and the outer circumferential surface of the sleeve 120. The first taper seal 100 is formed between the inner circumferential surface of the thrust plate 160 and an inclined surface 122 that is formed on the outer circumferential surface of the sleeve 120 and decreases the diameter of the sleeve 120 in a downward direction.

As shown in FIG. 7, the first taper seal 100 functions as a reservoir storing extra oil by accommodating oil 400 leaking from the lower thrust bearing 42 utilizing a capillary phenomenon to prevent the leakage of oil.

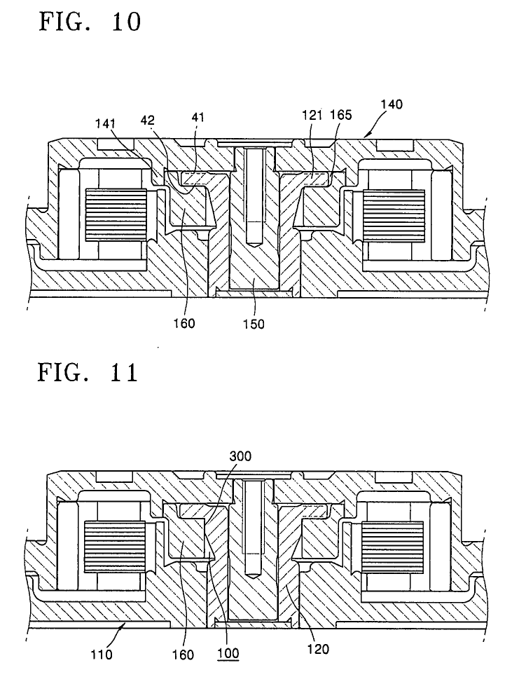

FIG. 10 shows a modified example of the thrust plate 160 of the hydrodynamic motor of FIG. 4. In the modified example, a coupling groove 165 in which the flange 121 is accommodated is formed in the upper surface of the thrust plate 160. The upper surface of the thrust plate 160 is located on the substantially same plane as the upper thrust bearing surface.

As shown in FIG. 10, when the coupling groove 165 having a depth that is substantially the same as the thickness of the flange 121 (including the upper/lower thrust bearing gap) is formed on the upper surface of the thrust plate 160, the thrust plate 160 can be easily assembled to the cylindrical wall 141. That is, after the sleeve 120 is coupled to the shaft 150, the thrust plate 160 is assembled to the cylindrical wall 141 until the upper surface of the thrust plate 160 contacts the lower surface of the hub 140. In the embodiment shown in FIG. 4, the assembly of the thrust plate 160 is inconvenient because the thrust plate 160 needs to be accurately assembled to the cylindrical wall 141 to accurately maintain the gap of the lower thrust bearing 42 when the thrust plate 160 is assembled to the cylindrical wall 141.

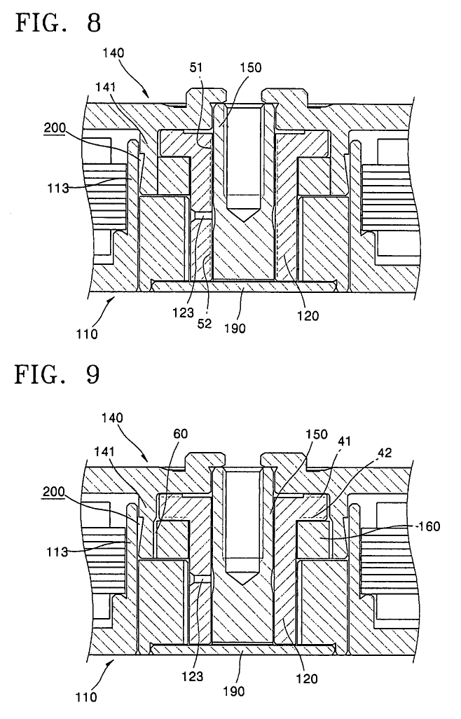

In the meantime, referring to FIG. 8 which shows another embodiment of the hydrodynamic bearing motor, a second taper seal 200 extending upward between the inner circumferential surface of the circular wall 113 of the base 110 and the outer circumferential surface of the cylindrical wall 141 is formed. Since the hub 140 forming the inside of the second taper seal 200 rotates, the leakage of oil can be more effectively prevented.

Also, in the above hydrodynamic bearing motor, a first pressure connection hole 123 is formed which connects the upper/lower journal bearings 51 and 52 and the second taper seal 200. Thus, the negative pressure of the journal bearings 51 and 52 is removed and generated air bubbles are smoothly exhausted through the second taper seal 200.

Referring to FIG. 9 which shows another embodiment of the hydrodynamic bearing motor, in addition to the embodiment of FIG. 8, a second pressure connection hole 60 is further formed in a boundary portion between the cylindrical wall 141 and the thrust plate 160 to connect the upper/lower thrust bearings 41 and 42 and the second taper seal 200. Thus, the negative pressure of the journal bearings 41 and 42 is removed and air bubbles generated in the lower thrust bearing 42 are smoothly exhausted so that the motor is smoothly operated.

Referring to FIG. 11 which shows another embodiment of the hydrodynamic bearing motor that is a modified example of the hydrodynamic bearing motor of FIG. 4, an auxiliary journal bearing 300 for preventing the leakage of oil is further provided between the inner circumferential surface of the thrust plate 160 and the outer circumferential surface of the sleeve 120. The auxiliary journal bearing 300 forms a groove for sealing in the inner circumferential surface of the thrust plate 160 so that the leakage of oil stored in the first taper seal 100 is effectively prevented.

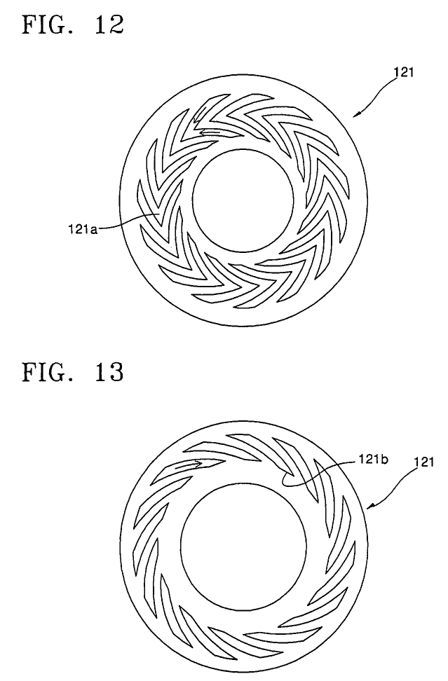

In the above embodiments, a groove 121a having an inward spiral shape as shown in FIG. 12 is formed on any one of the upper surface of the flange 121 and the hub 140 which form the upper thrust bearing 41. A groove 121b having a herring bone shape as shown in FIG. 13 is formed on any one of the lower surface of the flange 121 and the upper surface of the thrust plate 160 which form the lower thrust bearing 42.

The pressure at both ends of the lower thrust bearing 42 are made the same by making the groove of the lower thrust bearing 42 in a herring bone shape and the atmosphere is formed at the outer circumference of the upper thrust bearing 41.

The groove of the upper thrust bearing 41 has an inward spiral shape so that oil is sequentially supplied in the inner circumferential direction. Thus, the forces between the upper and lower thrust bearings are balanced. Although the upper thrust bearing 41 can be formed in a groove of a herring bone shape, by forming a groove in an inward spiral shape, a small thrust bearing can be embodied so that consumed power can be reduced.

When the groove of the lower thrust bearing 42 has a herring bone shape, since the oil moves toward the center of the lower thrust bearing 42, the leakage of oil storing in the first taper seal 100 can be prevented.

While this invention has been particularly shown and described with reference to preferred embodiments thereof, it will be understood by those skilled in the art that various changes in form and details may be made therein without departing from the spirit and scope of the invention as defined by the appended claims.

As described above, the present invention has the following advantages.

First, since a pair of the thrust bearings are provided without decreasing the length of the journal bearings of the motor, the stable operation characteristic and shock resistance of the motor can be realized.

Second, since the taper seal stores oil utilizing a capillary phenomenon, the leakage of oil can be prevented during the operation of the motor.

Third, since the pressure connection hole is formed, air bubbles generated in the bearing are smoothly exhausted and the negative pressure is removed so that the operation of the motor is made smooth.

Fourth, since the flange is formed in the sleeve and the thrust plate is forcibly fixed at the hub, the escape of the hub due to the external impact can be prevented.

What is claimed is:

1. A hydrodynamic bearing motor which rotatably supports a rotor by forming a hydrodynamic bearing by forming an oil gap between the rotor and a stator, wherein the stator comprises:
a base; and
a hollow sleeve fixedly coupled to the central portion of the base and having a flange formed at an upper end portion of the sleeve, and
the rotor comprises:
a shaft forming journal bearings by forming an oil gap in the hollow of the sleeve and rotatably coupled to the hollow of the sleeve 120;
a hub having the central portion to which an upper end portion of the shaft is fixedly coupled, having a cylindrical wall extending downward toward the outside of the flange from a lower surface of the hub, and forming an oil gap with an upper surface of the flange, thus forming an upper thrust bearing; and
a thrust plate fixedly coupled to an inner circumferential surface of the cylindrical wall and forming a lower thrust bearing with a lower surface of the flange.

2. The hydrodynamic bearing motor of claim 1, wherein a first taper seal connected to the lower thrust bearing and extending downward is formed between an inner circumferential surface of the thrust plate and an outer circumferential surface of the sleeve.

3. The hydrodynamic bearing motor of claim 1, wherein a circular wall extending upward is formed at the central portion of the base and a second taper seal extending upward is formed between an inner circumferential surface of the circular wall of the base and an outer circumferential surface of a cylindrical wall of the hub.

4. The hydrodynamic bearing motor of claim 3, wherein a first pressure connection hole connecting the journal bearings and the second taper seal is formed in the sleeve.

5. The hydrodynamic bearing motor of claim 3, wherein a second pressure connection hole connecting the upper/lower thrust bearings and the second taper is formed in a boundary portion between the cylindrical wall of the hub and the thrust plate.

6. The hydrodynamic bearing motor of claim 2, wherein an auxiliary journal bearing preventing the leakage of oil is formed between an inner circumferential surface of the thrust plate and an outer circumferential surface of the sleeve.

7. The hydrodynamic bearing motor of claim 1, wherein a groove having a herring bone shape is formed in any one of a lower surface of the flange and an upper surface of the thrust plate which form the lower thrust bearing.

8. The hydrodynamic bearing motor of claim 7, wherein a groove having an inward spiral shape is formed in any one of an upper surface of the flange and the hub which form the upper thrust bearing.

9. The hydrodynamic bearing motor of claim 1, wherein a coupling groove to accommodate the flange of the sleeve is formed in an upper surface of the thrust plate and the upper surface of the thrust plate is located on the substantially same plane as a surface of the upper thrust bearing.
